(19) United States
(12) Patent Application Publication
(10) Pub. No.: US 2021/0048297 A1
(43) Pub. Date: Feb. 18, 2021

(54) METHOD AND SYSTEM FOR SOLVING RIGID BODY ATTITUDE BASED ON FUNCTIONAL ITERATIVE INTEGRATION

(71) Applicant: SHANGHAI JIAO TONG UNIVERSITY, Shanghai (CN)

(72) Inventor: Yuanxin WU, Shanghai (CN)

(73) Assignee: SHANGHAI JIAO TONG UNIVERSITY, Shanghai (CN)

(21) Appl. No.: 16/963,515

(22) PCT Filed: Mar. 29, 2018
(86) PCT No.: PCT/CN2018/081179

§ 371 Date: Jul. 21, 2020

(30) Foreign Application Priority Data
Mar. 21, 2018 (CN) 201810236436.9

(51) Int. Cl. G01C 21/16; G01C 19/00

(52) U.S. Cl. CPC G01C 21/16; G01C 19/00

(57) ABSTRACT

A method for solving rigid body attitude based on functional iterative integration includes: fitting a Chebyshev polynomial function for an angular velocity according to gyro measurement values in a time interval; iteratively calculating a Chebyshev polynomial coefficient for a Rodrigues vector by using the obtained Chebyshev polynomial coefficient for the angular velocity and a Rodrigues vector integral equation, and performing polynomial truncation on the result at each iterative calculation according to a preset order; and calculating the Rodrigues vector according to the Chebyshev polynomial coefficient for the Rodrigues vector and the corresponding Chebyshev polynomial, so as to obtain attitude profile in the time interval in a form of quaternion. A system for solving rigid body attitude based on functional iterative integration includes a fitting module, an iterating module, and an attitude computation module.

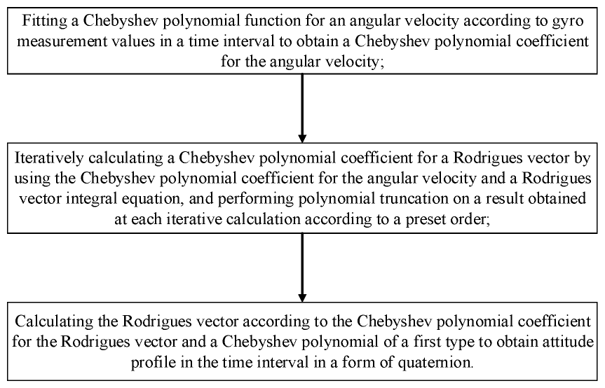

### CROSS REFERENCE TO THE RELATED APPLICATIONS

This application is the national phase entry of International Application No. PCT/CN2018/081179, filed on Mar. 29, 2018, which is based upon and claims priority to Chinese Patent Application No. 201810236436.9, filed on Mar. 21, 2018, the entire contents of which are incorporated herein by reference.

### TECHNICAL FIELD

The present invention relates to the field of test and measurement technology, and more particularly, to a method and system for solving rigid body attitude based on functional iterative integration.

### BACKGROUND

Calculation or estimation of rigid body motion in three-dimensional space is a core issue in many fields such as physics, robotic, navigation, machinery, computer vision and so on. Unlike the translational motion such as velocity and position, attitude cannot be measured directly and can only be obtained by indirect methods such as angular velocity integration or vector matching. Attitude calculation by angular velocity integration is completely autonomous, which does not need assistance from external information, so it is preferable in many applications, such as those where satellite navigation systems cannot work.

Recently, researchers in the art have proposed several attitude computation methods with high accuracy. The Chinese patent application No. 201710273489.3 proposes a method for solving rigid body attitude based on functional iterative integration, which includes: fitting a polynomial function for an angular velocity based on gyro measurement values in a time interval; iteratively calculating a Rodrigues vector by using the fitted polynomial function for the angular velocity and a Rodrigues vector integral equation; and then obtaining attitude profile in the time interval in a form of quaternion according to the iteration result. The method has an advantage of high calculation accuracy, but it does not make full use of characteristics of Chebyshev polynomial in the iterative process, and the order of the polynomial for the Rodrigues vector increases rapidly as the iterative process advances and thus the amount of calculation is huge, which is difficult to fulfill the real-time applications. For example, in a case that the polynomial for the angular velocity is fitted by using eight gyro measurement values, the order of the polynomial for the Rodrigues vector would be more than one thousand at the 7^{th} iteration. In fact, due to errors in angular velocity measurement, it is unnecessary to adopt such a high-order polynomial for the Rodrigues vector.

### SUMMARY

To solve the above technical problems in the prior art, the present invention aims to provide a method and system for solving rigid body attitude based on functional iterative integration.

The present invention provides a method for solving rigid body attitude based on functional iterative integration, including:

fitting step: fitting a Chebyshev polynomial function for an angular velocity according to gyro measurement values in a time interval;

iteration step: iteratively calculating a Chebyshev polynomial coefficient for a Rodrigues vector by using the obtained Chebyshev polynomial coefficient for the angular velocity and a Rodrigues vector integral equation, and performing polynomial truncation on a result at each iterative calculation according to a preset order; and

attitude computation step: calculating the Rodrigues vector according to the Chebyshev polynomial coefficient for the Rodrigues vector and a corresponding Chebyshev polynomial, so as to obtain attitude profile in the time interval in a form of quaternion.

Preferably, the gyro measurement values include angular velocity measurement values or angular increment measurement values.

Preferably, the fitting step specifically includes:

with respect to N angular velocity measurement values \tilde{ω}ₜ_{ₖ} or angular increment measurement values Δ\tilde{θ}ₜ_{ₖ} at time tₖ, k=1, 2, . . . N, let

$$t = \frac{{t}_{N}}{2} ( 1 + τ ) ,$$

mapping an original time interval to [−1 1]; and approximately fitting the angular velocity with a Chebyshev polynomial of an order of no greater than N−1:

$$\hat{ω} = {\sum }_{i = 0}^{n} {c}_{i} {F}_{i} ( τ ) , n \leq N - 1 ,$$

where, n denotes the order of the Chebyshev polynomial for the angular velocity, cᵢ denotes a coefficient vector of an i^{th} order Chebyshev polynomial, Fᵢ(τ) denotes an i^{th} order Chebyshev polynomial of a first type, and τ denotes a mapped time variable.

Preferably, the iterating step specifically includes:

at an l^{th} iterative calculation, adopting the following equation to calculate the Chebyshev polynomial for the Rodrigues vector:

$${\hat{g}}_{l} = {\sum }_{i = 0}^{{n}_{T}} {b}_{l , i} {F}_{i} ( τ ) ,$$

where, n_{T} is a preset truncation order, b_{l,i} is a coefficient of the i^{th} order Chebyshev polynomial at the l^{th} iterative calculation, and gₗ=0 when l=0.

Preferably, the Chebyshev polynomial coefficient for the Rodrigues vector is iteratively calculated as follows:

$${\hat{g}}_{l + 1} = \frac{{t}_{N}}{2} ( \begin{matrix}{\sum }_{i = 0}^{n} {c}_{i} {G}_{i , [ - 1 τ ]} + \frac{1}{4} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{16} {\sum }_{i = 0}^{{n}_{T}} {\sum }_{j = 0}^{{n}_{T}} {\sum }_{k = 0}^{n} {b}_{l , i} {b}_{l , j}^{T} {c}_{k} ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert \vert i - j \vert - k \vert , [ - 1 τ ]} )\end{matrix} ) , \\ {=}^{Δ} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ )$$

iterative calculation is performed until a convergence condition is satisfied or a preset maximum number of iterations is reached; as an approximation accuracy of the polynomial for the angular velocity does not exceed the order of N−1, a truncation order is set as n_{T}≥N.

A system for solving rigid body attitude based on functional iterative integration according to the present invention, including:

a fitting module, wherein the fitting module is configured to fit a Chebyshev polynomial function for an angular velocity according to gyro measurement values in a time interval;

an iterating module, wherein the iterating module is configured to iteratively calculate a Chebyshev polynomial coefficient for a Rodrigues vector by using the obtained Chebyshev polynomial coefficient for the angular velocity and a Rodrigues vector integral equation, and perform polynomial truncation on a result at each iterative calculation according to a preset order; and

an attitude computation module, wherein the attitude computation module is configured to calculate the Rodrigues vector according to the Chebyshev polynomial coefficient for the Rodrigues vector and a corresponding Chebyshev polynomial, so as to obtain attitude profile in the time interval in a form of quaternion.

Preferably, the gyro measurement values include angular velocity measurement values or angular increment measurement values.

Preferably, with respect to N angular velocity measurement values \tilde{ω}ₜ_{ₖ} or angular increment measurement values Δ\tilde{θ}ₜ_{ₖ} at time tₖ, k=1, 2, . . . N, let

$$t = \frac{{t}_{N}}{2} ( 1 + τ ) ,$$

the fitting module is specifically configured to map an original time interval to [−1 1] and approximately fit the angular velocity with a Chebyshev polynomial of an order of no greater than N−1:

$$\hat{ω} = {\sum }_{i = 0}^{n} {c}_{i} {F}_{i} ( τ ) , n \leq N - 1 ,$$

where, n denotes the order of the Chebyshev polynomial for the angular velocity, cᵢ denotes a coefficient vector of an i^{th} order Chebyshev polynomial, Fᵢ(τ) denotes an i^{th} order Chebyshev polynomial of a first type, and τ denotes a mapped time variable.

Preferably, the iteration module is specifically configured to adopt the following equation to calculate the Chebyshev polynomial for the Rodrigues vector at an l^{th} iterative calculation:

$${\hat{g}}_{l} = {\sum }_{i = 0}^{{n}_{T}} {b}_{l , i} {F}_{i} ( τ ) ,$$

where, n_{T} denotes a preset truncation order, b_{l,i} denotes a coefficient of the i^{th} order Chebyshev polynomial at the l^{th} iterative calculation, and gₗ=0 when l=0.

Preferably, the Chebyshev polynomial coefficient for the Rodrigues vector is iteratively calculated as follows:

$${\hat{g}}_{l + 1} = \frac{{t}_{N}}{2} ( \begin{matrix}{\sum }_{i = 0}^{n} {c}_{i} {G}_{i , [ - 1 τ ]} + \frac{1}{4} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{16} {\sum }_{i = 0}^{{n}_{T}} {\sum }_{j = 0}^{{n}_{T}} {\sum }_{k = 0}^{n} {b}_{l , i} {b}_{l , j}^{T} {c}_{k} ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert \vert i - j \vert - k \vert , [ - 1 τ ]} )\end{matrix} ) , \\ {=}^{Δ} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ )$$

iterative calculation is performed until a convergence condition is satisfied or a preset maximum number of iterations is reached; as an approximation accuracy of the polynomial for the angular velocity does not exceed the order of N−1, a truncation order is set as n_{T}≥N.

Compared with the prior art, the present invention has the following advantages.

The present invention is provided based on the technique of function iterative integration, which uses the Rodrigues vector to realize fast attitude reconstruction from gyro measurement. Attitude reconstruction based on gyro measurement adopts the Chebyshev polynomial with good numerical characteristics, transforms the iterative integration of Rodrigues vector into the iterative calculation of the corresponding Chebyshev polynomial coefficients, and then adopts an order truncation method to increase the calculation speed without significantly reducing the calculation accuracy.

### BRIEF DESCRIPTION OF THE DRAWING

Other features, objects, and advantages of the present invention will become more apparent, upon reading the detailed description of the non-limiting embodiments with reference to the following drawings.

FIGURE is a flowchart illustrating the present invention.

### DETAILED DESCRIPTION OF THE EMBODIMENTS

The present invention will be described in detail hereinafter with reference to specific embodiments. The following embodiments are described for facilitating those skilled in the art to further understand the present invention, but do not intend to limit the present invention in any way. It should be noted that, for those having ordinary skill in the art, several variations and improvements can be made without departing from the concept of the present invention, and such variations and improvements shall fall within the scope of protection of the present invention.

As shown in FIGURE, the method for solving rigid body attitude based on functional iterative integration includes:

1) fitting step: a Chebyshev polynomial function for an angular velocity is fitted according to gyro measurement values in a time interval;

2) iterating step: a Chebyshev polynomial coefficient for a Rodrigues vector is iteratively calculated by using the obtained Chebyshev polynomial coefficient for the angular velocity and a Rodrigues vector integral equation, and polynomial truncation is performed on the result obtained at each iterative calculation according to a preset order; and

3) attitude computation step: the Rodrigues vector is calculated according to the Chebyshev polynomial coefficient for the Rodrigues vector and the corresponding Chebyshev polynomial, so as to obtain attitude profile in the time interval in a form of quaternion.

The Chebyshev polynomial of the first type is defined on an interval [−1 1] and is given by the following iterative relationship:

F₀(x)=1, F₁(x)=x, Fᵢ₊₁(x)=2xFᵢ(x)−Fᵢ₋₁(x)

where, Fᵢ(x) denotes the i^{th} order Chebyshev polynomial of the first type.

In step 1), the Chebyshev polynomial function for the angular velocity is fitted according to gyro measurement values in the time interval.

With respect to N angular velocity measurement values \tilde{ω}ₜ_{ₖ} or angular increment measurement values Δ\tilde{θ}ₜ_{ₖ} at time tₖ, k=1, 2, . . . N, let

$$t = \frac{{t}_{N}}{2} ( 1 + τ ) ,$$

the original time interval is mapped to [−1 1]. The angular velocity is approximately fitted by a Chebyshev polynomial with an order of no greater than N−1:

$$\hat{ω} = {\sum }_{i = 0}^{n} {c}_{i} {F}_{i} ( τ ) , n \leq N - 1 \qquad ( 1 )$$

where, n denotes the order of the Chebyshev polynomial for the angular velocity, cᵢ denotes a coefficient vector of the i^{th} order Chebyshev polynomial, Fᵢ(τ) denotes the i^{th} order Chebyshev polynomial of the first type, and τ denotes the mapped time variable.

In case of angular velocity measurement, the coefficient cᵢ is determined by solving the following equation:

$${A}_{ω} [ \begin{matrix}{c}_{0}^{T} \\ {c}_{1}^{T} \\ ⋮ \\ {c}_{n}^{T}\end{matrix} ] {=}^{Δ} [ \begin{matrix}1 & {F}_{1} ( {τ}_{1} ) & … & {F}_{n} ( {τ}_{1} ) \\ 1 & {F}_{1} ( {τ}_{2} ) & … & {F}_{n} ( {τ}_{2} ) \\ ⋮ & ⋮ & ⋮ & ⋮ \\ 1 & {F}_{1} ( {τ}_{N} ) & … & {F}_{n} ( {τ}_{N} )\end{matrix} ] [ \begin{matrix}{c}_{0}^{T} \\ {c}_{1}^{T} \\ ⋮ \\ {c}_{n}^{T}\end{matrix} ] = [ \begin{matrix}{\hat{ω}}_{{t}_{1}}^{T} \\ {\hat{ω}}_{{t}_{2}}^{T} \\ ⋮ \\ {\hat{ω}}_{{t}_{N}}^{T}\end{matrix} ] , [ \begin{matrix}{c}_{0}^{T} \\ {c}_{1}^{T} \\ ⋮ \\ {c}_{n}^{T}\end{matrix} ] = {A}_{ω}^{- 1} [ \begin{matrix}{\hat{ω}}_{{t}_{1}}^{T} \\ {\hat{ω}}_{{t}_{2}}^{T} \\ ⋮ \\ {\hat{ω}}_{{t}_{N}}^{T}\end{matrix} ] \qquad ( 2 )$$

In case of angular increment measurement, the coefficient cᵢ is determined by solving the following equation:

$${A}_{θ} [ \begin{matrix}{c}_{0}^{T} \\ {c}_{1}^{T} \\ ⋮ \\ {c}_{n}^{T}\end{matrix} ] {=}^{Δ} [ \begin{matrix}{G}_{0 , [ {τ}_{0} {τ}_{1} ]} & {G}_{1 , [ {τ}_{0} {τ}_{1} ]} & … & {G}_{n , [ {τ}_{0} {τ}_{1} ]} \\ {G}_{0 , [ {τ}_{1} {τ}_{2} ]} & {G}_{1 , [ {τ}_{1} {τ}_{2} ]} & … & {G}_{n , [ {τ}_{1} {τ}_{2} ]} \\ ⋮ & ⋮ & ⋮ & ⋮ \\ {G}_{0 , [ {τ}_{N - 1} {τ}_{N} ]} & {G}_{1 , [ {τ}_{N - 1} {τ}_{N} ]} & … & {G}_{n , [ {τ}_{N - 1} {τ}_{N} ]}\end{matrix} ] [ \begin{matrix}{c}_{0}^{T} \\ {c}_{1}^{T} \\ ⋮ \\ {c}_{n}^{T}\end{matrix} ] = \frac{2}{{t}_{N}} [ \begin{matrix}Δ {\tilde{θ}}_{{t}_{1}}^{T} \\ Δ {\tilde{θ}}_{{t}_{2}}^{T} \\ ⋮ \\ Δ {\tilde{θ}}_{{t}_{N}}^{T}\end{matrix} ] , [ \begin{matrix}{c}_{0}^{T} \\ {c}_{1}^{T} \\ ⋮ \\ {c}_{n}^{T}\end{matrix} ] = \frac{2}{{t}_{N}} {A}_{θ}^{- 1} [ \begin{matrix}Δ {\tilde{θ}}_{{t}_{1}}^{T} \\ Δ {\tilde{θ}}_{{t}_{2}}^{T} \\ ⋮ \\ Δ {\tilde{θ}}_{{t}_{N}}^{T}\end{matrix} ] \qquad ( 3 )$$

where, T denotes the operation of vector transpose or matrix transpose, and the function G_{i,[τ}_{_{k−1}}_{τ}_{ₖ}_{]} is defined as follows:

$${G}_{i , [ {τ}_{k - 1} {τ}_{k} ]} = \{ \begin{matrix}( \frac{{iF}_{i + 1} ( {τ}_{k} )}{{i}^{2} - 1} - \frac{{τ}_{k} {F}_{i} ( {τ}_{k} )}{i - 1} ) - ( \frac{{iF}_{i + 1} ( {τ}_{k - 1} )}{{i}^{2} - 1} - \frac{{τ}_{k - 1} {F}_{i} ( {τ}_{k - 1} )}{i - 1} ) , & i \neq 1 \\ \frac{{τ}_{k}^{2} - {τ}_{k - 1}^{2}}{2} , & i = 1\end{matrix} \qquad ( 4 )$$

In step 2), the Chebyshev polynomial coefficient for the Rodrigues vector is iteratively calculated by using the obtained Chebyshev polynomial coefficient for the angular velocity and the Rodrigues vector integral equation, and polynomial truncation is performed on the result obtained at each iterative calculation according to a preset truncation order.

At the l^{th} iterative calculation, the Chebyshev polynomial for the Rodrigues vector is expressed as follows:

$${\hat{g}}_{l} = {\sum }_{i = 0}^{{n}_{T}} {b}_{l , i} {F}_{i} ( τ ) \qquad ( 5 )$$

where, n_{T} denotes a preset truncation order, b_{i,j} denotes a coefficient of the i^{th} order Chebyshev polynomial at the l^{th} iterative calculation, and gₗ=0 when l=0. The Chebyshev polynomial coefficient for the Rodrigues vector is iteratively calculated as follows:

$${\hat{g}}_{l + 1} = \frac{{t}_{N}}{2} ( \begin{matrix}{\sum }_{i = 0}^{n} {c}_{i} {G}_{i , [ - 1 τ ]} + \frac{1}{4} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{16} {\sum }_{i = 0}^{{n}_{T}} {\sum }_{j = 0}^{{n}_{T}} {\sum }_{k = 0}^{n} {b}_{l , i} {b}_{l , j}^{T} {c}_{k} ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert \vert i - j \vert - k \vert , [ - 1 τ ]} )\end{matrix} ) \\ {=}^{Δ} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ ) \qquad ( 6 )$$

The iterative calculation is performed until a convergence condition is satisfied or a preset maximum number of iterations is reached. In the above equation, × denotes the vector cross multiplication. According to equation (1), as the approximation accuracy of the polynomial for the angular velocity does not exceed the order of N−1, the truncation order is set as n_{T}≥N.

In step 3), the Rodrigues vector is calculated according to the Chebyshev polynomial coefficient for the Rodrigues vector and the corresponding Chebyshev polynomial, so as to obtain the attitude quaternion with respect to the start of the time interval.

The Rodrigues vector is calculated with reference to equation (5) according to the Chebyshev polynomial coefficient for the Rodrigues vector and the corresponding Chebyshev polynomial, so as to obtain the attitude quaternion with respect to the start of the time interval.

$$q = \frac{2 + g}{\sqrt{4 + {\vert g \vert}^{2}}} \qquad ( 7 )$$

As for attitude calculation in a large time interval, the large time interval may be divided into several small time intervals and the calculation may be performed for such small time intervals sequentially.

In principle, if a certain accuracy loss can be accepted, the method of fast attitude computation presented in the present invention is also applicable to other three-dimensional attitude parameters, such as the rotation vector. In this case, it is necessary to make corresponding adjustments to the equation (6) in step 2) and equation (7) in step 3) as follows.

In step 2), the Chebyshev polynomial coefficient for the rotation vector can be iteratively calculated as follows:

$${\hat{g}}_{l + 1} = \frac{{t}_{N}}{2} ( \begin{matrix}{\sum }_{i = 0}^{n} {c}_{i} {G}_{i , [ - 1 τ ]} + \frac{1}{2} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{12} {\sum }_{i = 0}^{{n}_{T}} {\sum }_{j = 0}^{{n}_{T}} {\sum }_{k = 0}^{n} [ {b}_{l , i} \times ( {b}_{l , j} \times {c}_{k} ) ] ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert \vert i - j \vert - k \vert , [ - 1 τ ]} )\end{matrix} ) \\ {=}^{Δ} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ ) \qquad ( 8 )$$

In step 3), the rotation vector is calculated according to the Chebyshev polynomial coefficient for the rotation vector and the corresponding Chebyshev polynomial, so as to obtain an attitude quaternion with respect to the start of the time interval.

$$q = cos \frac{\vert g \vert}{2} + \frac{g}{\vert g \vert} sin \frac{\vert g \vert}{2} \qquad ( 9 )$$

In addition to the rigid body attitude computation based on functional iterative integration, the present invention further provides a system for solving rigid body attitude based on functional iterative integration, including:

a fitting module, wherein the fitting module is configured to fit a Chebyshev polynomial function for an angular velocity according to gyro measurement values in a time interval;

an iterating module, wherein the iterating module is configured to iteratively calculate a Chebyshev polynomial coefficient for a Rodrigues vector by using the obtained Chebyshev polynomial coefficient for the angular velocity and a Rodrigues vector integral equation, and perform polynomial truncation on the result obtained at each iterative calculation according to a preset order; and

an attitude computation module, wherein the attitude computation module is configured to calculate the Rodrigues vector according to the Chebyshev polynomial coefficient for the Rodrigues vector and the corresponding Chebyshev polynomial, so as to obtain attitude profile in the time interval in a form of quaternion.

Specifically, with respect to N angular velocity measurement values \tilde{ω}ₜ_{ₖ} or angular increment measurement values Δ\tilde{θ}ₜ_{ₖ} at time tₖ, k=1, 2, . . . N, let

$$t = \frac{{t}_{N}}{2} ( 1 + τ ) ,$$

the fitting module is configured to map the original time interval to [−1 1] and approximately fit the angular velocity with a Chebyshev polynomial of an order of no greater than N−1:

$$\hat{ω} = {\sum }_{i = 0}^{n} {c}_{i} {F}_{i} ( τ ) , n \leq N - 1 \qquad ( 10 )$$

where, n denotes the order of the Chebyshev polynomial for the angular velocity, cᵢ denotes the coefficient vector of the i^{th} order Chebyshev polynomial, Fᵢ(τ) denotes an order Chebyshev polynomial of the first type, and τ denotes the mapped time variable.

In case of angular velocity measurement, the coefficient cᵢ is determined by solving the following equation:

$${A}_{ω} [ \begin{matrix}{c}_{0}^{T} \\ {c}_{1}^{T} \\ ⋮ \\ {c}_{n}^{T}\end{matrix} ] {=}^{Δ} [ \begin{matrix}1 & {F}_{1} ( {τ}_{1} ) & … & {F}_{n} ( {τ}_{1} ) \\ 1 & {F}_{1} ( {τ}_{2} ) & … & {F}_{n} ( {τ}_{2} ) \\ ⋮ & ⋮ & ⋮ & ⋮ \\ 1 & {F}_{1} ( {τ}_{N} ) & … & {F}_{n} ( {τ}_{N} )\end{matrix} ] [ \begin{matrix}{c}_{0}^{T} \\ {c}_{1}^{T} \\ ⋮ \\ {c}_{n}^{T}\end{matrix} ] = [ \begin{matrix}{\hat{ω}}_{{t}_{1}}^{T} \\ {\hat{ω}}_{{t}_{2}}^{T} \\ ⋮ \\ {\hat{ω}}_{{t}_{N}}^{T}\end{matrix} ] , [ \begin{matrix}{c}_{0}^{T} \\ {c}_{1}^{T} \\ ⋮ \\ {c}_{n}^{T}\end{matrix} ] = {A}_{ω}^{- 1} [ \begin{matrix}{\hat{ω}}_{{t}_{1}}^{T} \\ {\hat{ω}}_{{t}_{2}}^{T} \\ ⋮ \\ {\hat{ω}}_{{t}_{N}}^{T}\end{matrix} ] \qquad ( 11 )$$

In case of angular increment measurement, the coefficient cᵢ is determined by solving the following equation:

$${A}_{θ} [ \begin{matrix}{c}_{0}^{T} \\ {c}_{1}^{T} \\ ⋮ \\ {c}_{n}^{T}\end{matrix} ] {=}^{Δ} [ \begin{matrix}{G}_{0 , [ {τ}_{0} {τ}_{1} ]} & {G}_{1 , [ {τ}_{0} {τ}_{1} ]} & … & {G}_{n , [ {τ}_{0} {τ}_{1} ]} \\ {G}_{0 , [ {τ}_{1} {τ}_{2} ]} & {G}_{1 , [ {τ}_{1} {τ}_{2} ]} & … & {G}_{n , [ {τ}_{1} {τ}_{2} ]} \\ ⋮ & ⋮ & ⋮ & ⋮ \\ {G}_{0 , [ {τ}_{N - 1} {τ}_{N} ]} & {G}_{1 , [ {τ}_{N - 1} {τ}_{N} ]} & … & {G}_{n , [ {τ}_{N - 1} {τ}_{N} ]}\end{matrix} ] [ \begin{matrix}{c}_{0}^{T} \\ {c}_{1}^{T} \\ ⋮ \\ {c}_{n}^{T}\end{matrix} ] = \frac{2}{{t}_{N}} [ \begin{matrix}Δ {\tilde{θ}}_{{t}_{1}}^{T} \\ Δ {\tilde{θ}}_{{t}_{2}}^{T} \\ ⋮ \\ Δ {\tilde{θ}}_{{t}_{N}}^{T}\end{matrix} ] , [ \begin{matrix}{c}_{0}^{T} \\ {c}_{1}^{T} \\ ⋮ \\ {c}_{n}^{T}\end{matrix} ] = \frac{2}{{t}_{N}} {A}_{θ}^{- 1} [ \begin{matrix}Δ {\tilde{θ}}_{{t}_{1}}^{T} \\ Δ {\tilde{θ}}_{{t}_{2}}^{T} \\ ⋮ \\ Δ {\tilde{θ}}_{{t}_{N}}^{T}\end{matrix} ] \qquad ( 12 )$$

where, T denotes the operation of vector transpose or matrix transpose, and the function G_{i,[τ}_{_{k−1}}_{τ}_{ₖ}_{]} is defined as follows:

$${G}_{i , [ {τ}_{k - 1} {τ}_{k} ]} = \{ \begin{matrix}( \frac{i {F}_{i + 1} ( {τ}_{k} )}{{i}^{2} - 1} - \frac{{τ}_{k} {F}_{i} ( {τ}_{k} )}{i - 1} ) - ( \frac{i {F}_{i + 1} ( {τ}_{k - 1} )}{{i}^{2} - 1} - \frac{{τ}_{k - 1} {F}_{i} ( {τ}_{k - 1} )}{i - 1} ) , & i \neq 1 \\ \frac{{τ}_{k}^{2} - {τ}_{k - 1}^{2}}{2} , & i = 1\end{matrix} \qquad ( 13 )$$

Specifically, the iterating module iteratively calculates the Chebyshev polynomial for Rodrigues vector as follows.

At the l^{th} iterative calculation, the Chebyshev polynomial for the Rodrigues vector is expressed as follows:

$${\hat{g}}_{l} = {\sum }_{i = 0}^{{n}_{T}} {b}_{l , i} {F}_{i} ( τ ) \qquad ( 14 )$$

where, n_{T} denotes a preset truncation order, b_{l,i} denotes a coefficient of the i^{th} order Chebyshev polynomial at the l^{th} iterative calculation, and gₗ=0 when l=0.

The Chebyshev polynomial coefficient for the Rodrigues vector is iteratively calculated as follows:

$$\begin{matrix}{\hat{g}}_{l + 1} = \frac{{t}_{N}}{2} ( \begin{matrix}{\sum }_{i = 0}^{n} {c}_{i} {G}_{i , [ - 1 τ ]} + \frac{1}{4} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{16} {\sum }_{i = 0}^{{n}_{T}} {\sum }_{j = 0}^{{n}_{T}} {\sum }_{k = 0}^{n} {b}_{l , i} {b}_{l , j}^{T} {c}_{k} ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert i - j \vert - k , [ - 1 τ ]} )\end{matrix} ) \\ {=}^{△} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ )\end{matrix} \qquad ( 15 )$$

The iterative calculation is performed until a convergence condition is satisfied or a preset maximum number of iterations is reached. In the above equation, × denotes the vector cross multiplication. According to equation (10), as the approximation accuracy of the polynomial for the angular velocity does not exceed an order of N−1, the truncation order is set as n_{T}≥N.

The attitude computation module is configured to calculate the Rodrigues vector according to the Chebyshev polynomial coefficient for the Rodrigues vector and the corresponding Chebyshev polynomial, so as to obtain the attitude quaternion with respect to the start of the time interval.

The Rodrigues vector is calculated with reference to equation (14) according to the Chebyshev polynomial coefficient for the Rodrigues vector and the corresponding Chebyshev polynomial, so as to obtain the attitude quaternion with respect to the start of the time interval.

$$q = \frac{2 + g}{\sqrt{4 + {\vert g \vert}^{2}}} \qquad ( 16 )$$

As for attitude calculation in a large time interval, the large time interval may be divided into several small time intervals and the calculation may be performed for such small time intervals sequentially.

In principle, if a certain accuracy loss can be accepted, the system of fast attitude computation presented in the present invention is also applicable to other three-dimensional attitude parameters, such as the rotation vector. In this case, it is necessary to make corresponding adjustments to the equations (15) and (16) as follows.

The iterating module iteratively calculates the Chebyshev polynomial coefficients for the rotation vector as follows:

$$\begin{matrix}{\hat{g}}_{l + 1} = \frac{{t}_{N}}{2} ( \begin{matrix}{\sum }_{i = 0}^{n} {c}_{i} {G}_{i , [ - 1 τ ]} + \frac{1}{2} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{12} {\sum }_{i = 0}^{{n}_{T}} {\sum }_{j = 0}^{{n}_{T}} {\sum }_{k = 0}^{n} [ {b}_{l , i} \times ( {b}_{l , j} \times {c}_{k} ) ] ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert i - j \vert - k , [ - 1 τ ]} )\end{matrix} ) \\ {=}^{△} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ )\end{matrix} \qquad ( 17 )$$

The attitude computation module calculates the rotation vector according to the Chebyshev polynomial coefficient for the rotation vector and the corresponding Chebyshev polynomial, so as to obtain an attitude quaternion with respect to the start of the time interval.

$$q = cos \frac{\vert g \vert}{2} + \frac{g}{\vert g \vert} sin \frac{\vert g \vert}{2} \qquad ( 18 )$$

Those skilled in the art shall understand that, in addition to implementing the system and its various devices, modules and units according to the present invention in a pure computer-readable program code, they may also be implemented to realize the same functions in form of logic gates, switches, application specific integrated circuits, programmable logic controllers, embedded microcontrollers and the like, by performing logic programming on the steps of the method. Therefore, the system and its various devices, modules and units provided by the present invention may be regarded as hardware components, and the devices, modules and units included therein for realizing various functions can also be regarded as structures within the hardware component. Besides, the devices, the modules and the units for realizing various functions can also be regarded as software modules, or structures within hardware components for implementing the method.

The specific embodiments of the present invention have been described above. It should be understood that the present invention is not limited to the above specific embodiments, and those skilled in the art may make various variations or modifications within the scope of the appended claims, which does not affect the essence of the present invention. The embodiments of the present application and the features in the embodiments can be arbitrarily combined with each other, as long as they are not conflict with each other.

What is claimed is:

1. A method for solving rigid body attitude based on functional iterative integration, comprising:
fitting step: fitting a Chebyshev polynomial function for an angular velocity according to gyro measurement values in a time interval to obtain a Chebyshev polynomial coefficient for the angular velocity;
iterating step: iteratively calculating a Chebyshev polynomial coefficient for a Rodrigues vector by using the Chebyshev polynomial coefficient for the angular velocity and a Rodrigues vector integral equation, and performing polynomial truncation on a result obtained at each iterative calculation according to a preset order; and
attitude computation step: calculating the Rodrigues vector according to the Chebyshev polynomial coefficient for the Rodrigues vector and a Chebyshev polynomial of a first type to obtain attitude profile in the time interval in a form of quaternion.

2. The method for solving rigid body attitude based on functional iterative integration of claim 1, wherein, the gyro measurement values comprise angular velocity measurement values or angular increment measurement values.

3. The method for solving rigid body attitude based on functional iterative integration of claim 1, wherein, the fitting step specifically comprises:
with respect to N angular velocity measurement values \tilde{ω}ₜ_{ₖ} or angular increment measurement values Δ\tilde{θ}ₜ_{ₖ} at time tₖ, k=1, 2, . . . N, let
$$t = \frac{{t}_{N}}{2} ( 1 + τ ) ,$$
mapping an original time interval to [−1 1]; and approximately fitting the angular velocity with a Chebyshev polynomial of an order of no greater than N−1:
$$\hat{ω} = {\sum }_{i = 0}^{n} {c}_{i} {F}_{i} ( τ ) , n \leq N - 1 ,$$
where, n denotes the order of the Chebyshev polynomial for the angular velocity, cᵢ denotes a coefficient vector of an i^{th} order Chebyshev polynomial, Fᵢ(τ) denotes an i^{th} order Chebyshev polynomial of the first type, and τ denotes a mapped time variable.

4. The method for solving rigid body attitude based on functional iterative integration of claim 3, wherein, the iterating step specifically comprises:
at an l^{th} iterative calculation, adopting the following equation to calculate the Chebyshev polynomial for the Rodrigues vector:
$${\hat{g}}_{l} = {\sum }_{i = 0}^{{n}_{T}} {b}_{l , i} {F}_{i} ( τ ) ,$$
where, n_{T} denotes a preset truncation order, b_{l,i} denotes a coefficient of the i^{th} order Chebyshev polynomial at the l^{th} iterative calculation, and gₗ=0 when l=0.

5. The method for solving rigid body attitude based on functional iterative integration of claim 4, wherein, the Chebyshev polynomial coefficient for the Rodrigues vector is iteratively calculated as follows:
$$\begin{matrix}{\hat{g}}_{l + 1} = \frac{{t}_{N}}{2} ( \begin{matrix}{\sum }_{i = 0}^{n} {c}_{i} {G}_{i , [ - 1 τ ]} + \frac{1}{4} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{16} {\sum }_{i = 0}^{{n}_{T}} {\sum }_{j = 0}^{{n}_{T}} {\sum }_{k = 0}^{n} {b}_{l , i} {b}_{l , j}^{T} {c}_{k} ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert i - j \vert - k , [ - 1 τ ]} )\end{matrix} ) , \\ {=}^{△} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ )\end{matrix}$$
wherein, iterative calculation is performed until a convergence condition is satisfied or a preset maximum number of iterations is reached; as an approximation accuracy of the Chebyshev polynomial for the angular velocity does not exceed the order of N−1, a truncation order is set as n_{T}≥N.

6. A system for solving rigid body attitude based on functional iterative integration, comprising:
a fitting module, wherein the fitting module is configured to fit a Chebyshev polynomial function for an angular velocity according to gyro measurement values in a time interval to obtain a Chebyshev polynomial coefficient for the angular velocity;
an iterating module, wherein the iterating module is configured to iteratively calculate a Chebyshev polynomial coefficient for a Rodrigues vector by using the Chebyshev polynomial coefficient for the angular velocity and a Rodrigues vector integral equation, and perform polynomial truncation on a result at each iterative calculation according to a preset order; and
an attitude computation module, wherein the attitude computation module is configured to calculate the Rodrigues vector according to the Chebyshev polynomial coefficient for the Rodrigues vector and a Chebyshev polynomial corresponding to the Rodrigues vector to obtain attitude profile in the time interval in a form of quaternion.

7. The system for solving rigid body attitude based on functional iterative integration according to claim 6, wherein, the gyro measurement values comprise angular velocity measurement values or angular increment measurement values.

8. The system for solving rigid body attitude based on functional iterative integration according to claim 6, wherein, with respect to N angular velocity measurement values \tilde{ω}ₜ_{ₖ} or angular increment measurement values Δ\tilde{θ}ₜ_{ₖ} at time tₖ, k=1, 2, . . . N, let
$$t = \frac{{t}_{N}}{2} ( 1 + τ ) ,$$
the fitting module is specifically configured to map an original time interval to [−1 1] and approximately fit the angular velocity with a Chebyshev polynomial of an order not of greater than N−1:
$$\hat{ω} = {\sum }_{i = 0}^{n} {c}_{i} {F}_{i} ( τ ) , n \leq N - 1 ,$$
where, n denotes the order of the Chebyshev polynomial for the angular velocity, cᵢ denotes a coefficient vector of an i^{th} order Chebyshev polynomial, Fᵢ(τ) denotes an i^{th} order Chebyshev polynomial of a first type, and τ denotes a mapped time variable.

9. The system for solving rigid body attitude based on functional iterative integration according to claim 8, wherein, the iteration module is specifically configured to adopt the following equation to calculate the Chebyshev polynomial for the Rodrigues vector at an l^{th} iterative calculation:
$${\hat{g}}_{l} = {\sum }_{i = 0}^{{n}_{T}} {b}_{l , i} {F}_{i} ( τ ) ,$$
where, n_{T} denotes a preset truncation order, b_{l,i} denotes a coefficient of the i^{th} order Chebyshev polynomial at the l^{th} iterative calculation, and gₗ=0 when l=0.

10. The system for solving rigid body attitude based on functional iterative integration according to claim 9, wherein, the Chebyshev polynomial coefficient for the Rodrigues vector is iteratively calculated as follows:
$$\begin{matrix}{\hat{g}}_{l + 1} = \frac{{t}_{N}}{2} ( \begin{matrix}{\sum }_{i = 0}^{n} {c}_{i} {G}_{i , [ - 1 τ ]} + \frac{1}{4} {\sum }_{i = 0}^{{n}_{T}} {\sum }_{j = 0}^{n} {b}_{l , i} \times {c}_{j} ( {G}_{i + j , [ - 1 τ ]} + {G}_{\vert i - j \vert , [ - 1 τ ]} ) + \\ \frac{1}{16} {\sum }_{i = 0}^{{n}_{T}} {\sum }_{j = 0}^{{n}_{T}} {\sum }_{k = 0}^{n} {b}_{l , i} {b}_{l , j}^{T} {c}_{k} ( {G}_{i + j + k , [ - 1 τ ]} + {G}_{\vert i + j - k \vert , [ - 1 τ ]} + {G}_{\vert i - j \vert + k , [ - 1 τ ]} + {G}_{\vert i - j \vert - k , [ - 1 τ ]} )\end{matrix} ) , \\ {=}^{△} {\sum }_{i = 0}^{2 {n}_{T} + n + 1} {b}_{l + 1 , i} {F}_{i} ( τ ) {\approx }^{polynomial truncation} {\sum }_{i = 0}^{{n}_{T}} {b}_{l + 1 , i} {F}_{i} ( τ )\end{matrix}$$
wherein, iterative calculation is performed until a convergence condition is satisfied or a preset maximum number of iterations is reached; as an approximation accuracy of the Chebyshev polynomial for the angular velocity does not exceed the order of N−1, a truncation order is set as n_{T}≥N.
